(19) United States
(12) Patent Application Publication
(10) Pub. No.: US 2024/0116077 A1
(43) Pub. Date: Apr. 11, 2024

(54) HIGH GLOSS POLISHABLE COATINGS WITH MATT AND/OR STRUCTURED METALLIC EFFECT AND METHOD FOR THEIR PREPARATION

(71) Applicant: BASF COATINGS GMBH, Mùnster (DE)

(72) Inventors: Hendrik Franke, Mùnster (DE); Thomas Koehler, Mùnster (DE)

(21) Appl. No.: 17/768,243

(22) PCT Filed: Oct. 14, 2020
(86) PCT No.: PCT/EP2020/078837

§ 371 Date: Apr. 12, 2022

(30) Foreign Application Priority Data
Oct. 14, 2019 (EP) 19203017.9

(51) Int. Cl. B05D 5/06; B05B 7/24; B05D 7/00; C09D 5/00; C09D 7/40; C09D 7/42; C09D 7/61; C09D 133/06; C09D 175/04; C23C 18/16; C23C 18/42

(52) U.S. Cl. CPC B05D 5/068; B05B 7/2491; B05D 7/57; C09D 5/002; C09D 7/42; C09D 7/61; C09D 7/69; C09D 133/066; C09D 175/04; C23C 18/165; C23C 18/42

(57) ABSTRACT

Disclosed herein is a method for producing a multi-layer coating on a substrate including the steps of (i) forming a primer coat layer (P) on a substrate, (ii) forming a silver metal layer (S) onto the surface of the coating layer (P); and (iii) forming one or more clear top coat layers (T) onto the surface of the silver metal layer (S), where the primer coat layer contains one or more particulate components selected from the group consisting of matting agents and structuring agents and where the silver metal layer (S) is formed by reductive deposition from an aqueous alkaline ammoniac solution containing a soluble silver salt, by use of a reducing agent. Further disclosed herein are multi-layer coated substrates obtainable according to the above method.

The invention relates to high-gloss, polishable, multi-layer coated substrates comprising a matt and/or structured metallic effect. The invention further relates to a method for their production.

### BACKGROUND

The coating of surfaces of substrates may be useful for a variety of reasons, such as to protect the surfaces, alter their physical properties, for decorative purposes, or to improve the structural integrity of the substrates. Therefore, the interest in methods with which a broad spectrum of different substrates can be coated, is very high. Most important is the coating of metal and plastics, however wood, glass and other substrates are also important.

In recent years, there is an increasing demand for decorative coatings having a matt and/or structured surface, but still providing a high gloss and metallic effect. Particularly in automotive and motorcycle coating, coating of appliances and many other areas such surfaces having a matt silver-like effect are highly desirable.

While there are known methods for producing surfaces having a silver-like appearance, such processes typically lead to surfaces showing a mirror effect rather than being matt and/or structured. Such methods particularly use a two-component spray gun, in which a silver salt solution and a reducing solution emerge from two separate nozzles. As the solutions mix, the reducing solution reduces the silver salt contained in the silver salt solution and metallic silver precipitates onto the surface. The precipitated silver attaches to the substrate and forms the desired mirrored surface. After cleaning and drying the mirrored surface, a transparent or translucent protective lacquer is usually applied. If such transparent or translucent protective layer is damaged, in many cases corrosion occurs, which can up to a certain extent, being delayed by deposition of the silver layer onto a primer layer containing zinc particles. Zinc particles form a local element with the silver layer and act as a sacrificial anode. However, any reaction between cured layers of a multilayer coating will deteriorate other properties, typically mechanical properties and thus is to be avoided.

WO 2017/194547 A1 solves this problem by providing surfaces with a mirror-effect by forming a silver layer onto a zinc particle-free primer coat layer containing special organic anti-corrosion agents and afterwards forming a protective transparent or translucent layer onto the silver layer. Again, the appearance of the coated substrate is rather mirror-like than providing a matt and/or structured appearance.

Typically, matt and/or structured appearances of mono- or multi-layer coatings are provided by so-called matting agents such as waxes or silica particles and/or structuring agents, being present in the outermost layer of a multilayer coating system, i.e. the topcoat layer.

While such top coat layers can be applied on substantially every coated substrate to provide such substrate with a matt and/or structured effect, the haptics of such surface is rather rough (micro-roughness), the preceding layer is somewhat covered by the particles providing the matt and/or structured effect, thus reducing metallic effects provided by the preceding layer(s) and the most outer surface becomes susceptible for un-repairable scratches and other damages. Polishing of such surface is not an option, since the polished parts will lose their matt and/or structured appearance due to the abrasion of the particles contained at the surface of the coating. Normally, the complete coated part will have to be re-coated to regain a homogeneous matt and/or structured effect on the whole surface of the part to be repair-coated.

Therefore, it was the aim of the present inventors to provide coatings having a matt and/or structured, preferably at least matt metallic effect, while still having a high gloss and being polishable, when damaged. The coating should be easily applicable on many substrates and should preferably require only three layers to provide the effect.

### SUMMARY

This aim of the present invention was achieved by providing a method for producing a multi-layer coating on a substrate comprising the steps of
(i) forming a primer coat layer (P) on a substrate;
(ii) forming a silver metal layer (S) onto the surface of the coating layer (P); and
(iii) forming one or more clear top coat layers (T) onto the surface of the silver metal layer (S), wherein
   the primer coat layer contains one or more particulate components selected from the group consisting of matting agents and structuring agents and wherein the silver metal layer (S) is formed by reductive deposition from an aqueous alkaline ammoniac solution containing a soluble silver salt, by use of a reducing agent.

Contrary to the well-established method of providing the top coat layer with matting agents and/or structuring agents to achieve a matt and/or structured effect, the present invention teaches to provide a primer coat layer (P) with particulate matting agents and/or structuring agents, thereby giving the primer coat layer a rough surface due to the presence of a “hills and valleys” topography formed by the particulate components contained therein.

The term “matting agent” as used herein, is used according to its definition in ISO 4618:2014 (EN) (Paints and Varnishes). Typical matting agents which can be used according to the present invention are described below in the detailed description. The term “structuring agent” as used herein, refers to species providing a homogeneous texture to the coating beyond simple matting.

The surface of the primer coat layer (P) is subsequently coated with a silver metal layer (S) which is similar to the surface topography of the primer coat layer (P) and provides the metallic effect to the multi-layer coating.

The term “silver metal layer (S)” as used herein means that the silver metal being present in the layer is essentially present in its elemental metallic state, i.e. as Ag⁰.

Finally, the silver metal layer (S) is coated with at least one, preferably just one clear top coat layer (T). This top coat layer (T) serves as a protective layer and should typically not interfere with the effect provided by the combination of the primer coat layer (P) with the silver metal layer (S). Since the top coat layer (T) does typically not contain particulate components of the above kind or any other kind, the surface of the top coat layer is highly glossy and provides a high-gloss effect to the subjacent matt and/or structured topography of the silver metal layer (S). Such top coat layer is polishable, since no abrasion of particulate components is to be suspected.

The term “clear top coat layer” as used herein is to be understood in accordance with the definition of the terms “clear coating material” and “top coat” as defined in ISO 4618:2014 (EN). With other words “clear top coat layers” are “top coat” layers (i.e. final coat layers of a coating system) formed by application of a “clear coating material”, i.e. a coating material which when applied to a substrate forms a solid transparent film having protective, decorative or specific technical properties.

Further subject of the present invention is a multi-layer coated substrate obtainable according to the method according to the present invention.

### DETAILED DESCRIPTION

### Method According to the Present Invention

### Step (i)

The method of the present invention is a method comprising at least steps (i), (ii) and (iii), carried out subsequently in this order.

### Substrates

In the method of the present invention a wide variety of materials can be used as substrates. Preferably the substrate materials are chosen from the group consisting of metals, polymers, wood, glass, mineral-based materials and composites of any of the afore-mentioned materials.

The term metal comprises metallic elements like iron, aluminum, zinc, copper and the like as well as alloys such as steel like cold-rolled steel, galvanized steel and the like. Polymers can be thermoplastic, duroplastic or elastomeric polymers, duroplastic and thermoplastic polymers being preferred. Mineral-based materials encompass materials such as e.g. hardened cement and concrete. Composite materials are e.g. fiber-reinforced polymers etc.

Of course, it is possible to use pre-treated substrates in step (i), where the pre-treatment regularly depends on the chemical nature of the substrate.

Preferably, the substrates are cleaned before use, e.g. to remove dust, fats, oils or other substances which typically prevent a good adhesion of further coatings. The substrate can further be treated with adhesion promoters to increase the adhesion of subsequent coatings.

Metallic substrates may comprise a so-called conversion coat layer and/or electrodeposition coat layer before being coated with the primer coat layer (P).

For polymeric substrates pretreatment may include, for example, treatment with fluorine, or a plasma, corona or flame treatment. Often the surface is also sanded and/or polished. The cleaning can also be done manually by wiping with solvents with or without previous grinding or by means of common automated procedures, such as carbon dioxide cleaning.

Any of the above substrates can also be pre-coated with one or more fillers and/or one or more basecoat prior to the formation of the primer coat layer (P). Such fillers may contain color pigments and/or effect pigments such as metallic effect pigments as e.g. aluminum pigments; or pearlescent pigments as e.g. mica pigments.

### Primer Coat Layer (P)

The primer coat layer (P) is formed by application of a primer composition onto the pretreated or non-pretreated, pre-coated or non-precoated substrate.

### Primer Compositions

The primer compositions can be water-borne compositions or solvent-borne compositions. Preferably the primer compositions are solvent-borne compositions.

The term “water-borne coating composition” as used herein denotes for a coating composition wherein more than 50% by weight of the volatile content of the coating composition is water, while the term “solvent-based coating composition” denotes for a coating composition wherein up to 50% by weight of the volatile content of the coating composition differs from water, preferably wherein up to 50% by weight of the volatile content of the coating composition are one or more organic solvents.

The “volatile content” can be determined by drying 1 g of a coating composition at 120° C. for 90 minutes. The weight loss equals the volatile content of the respective coating composition, the remaining part is the “solids content”. The volatile content can be collected in a cold trap and analyzed by conventional methods known to one skilled in the art. Water content can e.g. be determined by Karl Fischer titration.

The afore-mentioned definitions apply to all types of coating compositions as described herein, irrespective of whether it is a primer composition or a top coat composition.

In practice and preferably herein “water-borne coating compositions” contain, based on the volatile content of the coating composition, less than 25% by weight of organic solvents, more preferably less than 20% by weight and most preferably less than 15% by weight of organic solvents.

In practice and preferably herein “solvent-borne coating compositions” contain, based on the total weight of the coating composition, less than 5% by weight of water, more preferably less than 3% by weight and most preferably less than 1% by weight of water or substantially water-free.

Furthermore, the primer compositions can be one-pack compositions or two-pack compositions. Preferably the primer compositions are two-pack compositions.

A “one-pack coating composition”—as defined in the textbook “Römpp Lexikon Lacke und Druckfarben”, Thieme, 1998—is a coating composition, which, contrary to the below described two-pack coating compositions are produced and supplied in a way that they contain the base resins and the curing agents in one composition without premature reaction between the ingredients. Reaction is preferably caused either by heating/baking or reaction with air moisture. This definition is valid for all one-pack coating compositions as described herein, irrespective of whether it is a primer composition or a top coat composition.

A “two-pack coating composition”—as defined in the textbook “Römpp Lexikon Lacke und Druckfarben”, Thieme, 1998—is a composition were curing is affected by mixing two components (a master batch “Stammlack” and a curing agent “Härter”) in a specified mixing ratio. The components themselves are not coating compositions, since they are not apt to film formation or do not form durable films. This definition is valid for all two-pack coating compositions as described herein, irrespective of whether it is a primer composition or a top coat composition.

Most preferred primer compositions to be used in step (i) for the formation of the primer coat layer (P) are solvent-borne, two-pack compositions.

### Solvent-Borne, Two-Pack Compositions Used as the Preferred Primer Composition

Preferred two-pack compositions to be used as the primer composition in the method according to the present invention are epoxy two-pack compositions, the epoxy resin being the master batch and preferably an amine being the curing agent; and polyol-isocyanate two-pack compositions, the polyol being the master batch and the di- and/or polyisocyanate being the curing agent.

In the epoxy primer compositions, the epoxy resin and the associated curing agent form, as a reactive mixture, the epoxy resin binder, which cures by way of polyaddition reactions. The epoxy resins (EP resins), also referred to as epoxide resins, are oligomeric compounds having more than one epoxide group per molecule. On curing, monomeric and oligomeric components of the binder, through the crosslinking reaction, form three-dimensional networks of high molecular mass. Network nodes originate from the reaction of the functional groups of the epoxy resins and curing agents. In this reaction, strong covalent chemical bonds are formed. The fully cured binders (thermoset networks) are substantially insoluble and infusible, and are also highly robust chemically and mechanically (see Kittel, “Lehrbuch der Lacke and Beschichtungen”, volume 2, second edition, 1998, pp. 268-269).

Epoxy resins contain in their molecule more than one oxirane ring and can be converted into cured epoxy resins with the curing component through reaction of the oxirane rings. Customary epoxy resins are prepared by reaction of reactive phenols, alcohols, acids, and amines with epichlorohydrin, and contain the oxirane rings in the form of a glycidyl group. The number of reactive structures forming epoxy resins through a reaction with epichlorohydrin is virtually unlimited, and so there are a large number of industrially significant resins. Furthermore, unsaturated aliphatic and cycloaliphatic compounds have been epoxidized directly using peracetic acid, for example.

In principle all epoxy resins obtainable via the aforementioned processes can be used for the purposes of the present invention.

The epoxy resins which can be used in accordance with the invention are preferably those selected from the group consisting of glycidyl ethers, such as bisphenol-A-diglycidyl ether, bisphenol-F-diglycidyl ether, epoxide-novalak, epoxide-o-cresol-novolak, 1,3-propane-, 1,4-butane- or 1,6-hexane-diglycidyl ethers and polyalkylene oxide glycidyl ethers; glycidyl esters, such as diglycidyl hexahydrophthalate; glycidylamines, such as diglycidylaniline or tetraglycidylmethylenedianiline; cycloaliphatic epoxides, such as 3,4-epoxycyclohexylepoxyethane or 3,4-epoxycyclohexylm ethyl-3,4-epoxycyclohexanecarboxylate; and glycidyl isocyanurates, such as trisglycidyl isocyanurate.

Further epoxy resins suitable for the two-pack primer compositions of the invention are also disclosed in EP 0 835 910 A1, EP 2 085 426 A1 or EP 1141071 A1, for example.

Curing agents useful to cure epoxy resins are designated in their function as “epoxide curing agents”, in line with the relevant textbook literature (for example: Kittel, “Lehrbuch der Lacke and Beschichtungen”, volume 2, 2^{nd} edition, 1998, pp. 267 to 318).

The epoxy curing agents are substances with a functionality of two or more whose functional groups are able to react with oxirane groups (compounds having active hydrogen, in particular with hydrogen bonded to nitrogen or oxygen). The curing agents are preferably employed substantially stoichiometrically relative to the epoxy resin. The concentration of the oxirane rings in the epoxy resin can be determined titrimetric, for example. The amount of curing agent required can be calculated from the equivalent weight of active hydrogen (“H-active equivalent weight”) of the curing agent.

The curing agents which can be used in accordance with the invention are preferably those selected from the group consisting of diamines and polyamines, polyamides, and cyclic carboxylic anhydrides. Among the classes of compounds referred to above, the diamines and polyamines and polyamides are especially preferred. Especially preferred are di- and polyamines. In its most preferred embodiment, therefore, the curing agent may also be termed an amine curing agent.

Particularly preferred di- and polyamines may be selected from the group of aliphatic amines, such as diethylenetriamine, triethylenetetramine or 3,3′,5-trimethylhexamethylenediamine; cycloaliphatic amines, such as 1,2-cyclohexyldiamine, isophoronediamine and its isomer mixtures, or m-xylylenediamine; aromatic amines, such as methylenedianiline or 4,4-diaminodiphenyl sulfone; modified amines, such as Mannich bases (for example, diethylene triamine-phenol Mannich base), or amine adducts of 3,3′,5-trimethylhexamethylenediamine and bisphenol-A-diglycidyl ether.

Particularly preferred curing agents of the polyamide type are polyaminoamides or dicyandiamide.

Representatives of cyclic carboxylic anhydrides are, for example, phthalic anhydride or hexahydrophthalic anhydride. The cyclic carboxylic anhydrides are used primarily, however, in hot-curing epoxy resin systems, while the present invention relates primarily and preferably to systems which cure even at room temperature (or below 100° C.).

A non-exhaustive compilation of suitable amine curing agents is found in EP 0835 910 A1.

In the polyol-isocyanate primer compositions the polyol and the associated curing agent, namely the isocyanate, form a reactive mixture, which cures by way of polyaddition reactions.

Suitable polyols are in principle all polyhydroxy-functional compounds which comprise at least two hydroxyl groups. Where trihydric or polyhydric alcohols or polyhydroxy compounds are used, the resulting products have a greater or smaller degree of branching and crosslinking, with a pattern of properties which can be varied within wide limits through appropriate selection of the co-reactants.

Particularly suitable polyols are polyester polyols, polyether polyols and acrylic polyols such as poly(meth)acrylate polyols, although monomeric polyols with molecular uniformity can also be used.

Polyester polyols can be obtained by reaction of polycarboxylic acids and their reactive derivatives such as their anhydrides and halides with an excess of preferably monomeric polyols. Examples of monomeric polyols are ethylene glycol, diethylene glycol, triethylene glycol, dipropylene glycol, butanediol, glycerol, trimethylolpropane, pentaerythritol, and the like. Dicarboxylic acids used are frequently adipic acid and phthalic acids, including hydrogenated phthalic acids, and also their anhydrides. Polyester polyols are also obtainable, however, by ring-opening polymerization of lactones with preferably monomeric polyols. Examples of suitable lactones are butyrolactone, caprolactone, and valerolactone.

Polyether polyols are obtained preferably by addition reaction of ethylene oxide and/or propylene oxide with preferably monomeric polyols.

It is also possible to used polyether-polyester-polyol, which are obtainable when using a polyether polyol as a polyol in the manufacture of the polyester polyol, i.e. as a reactant with polycarboxylic acids and their reactive derivatives such as their anhydrides and halides.

However, most preferred is the use of polyhydroxyfunctional acrylic resins as polyols, also called poly(meth)acrylate polyols. The term “(meth)acrylate” encompasses “methacrylates” as well as “acrylates”

The poly(meth)acrylate polyols that are particularly preferred are generally copolymers formed from hydroxyl-functional (meth)acrylates and non-hydroxy-functional monomers, particularly preferred non-hydroxy-functional (meth)acrylates.

Hydroxyl-containing monomer units used are preferably hydroxyalkyl acrylates and/or hydroxyalkyl methacrylates, such as in particular 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and particularly 4-hydroxybutyl acrylate and/or 4-hydroxy-butyl methacrylate.

Further monomer units used for the poly(meth)acrylate polyols are preferably alkyl methacrylates and/or alkyl methacrylates, such as, preferably, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate, or, in particular, cyclohexyl acrylate and/or cyclohexyl methacrylate.

Further monomer units which can be used for the poly(meth)acrylate polyols are vinylaromatic hydrocarbons, such as vinyltoluene, alpha-methylstyrene or particularly styrene, amides or nitriles of acrylic or methacrylic acid, vinyl esters or vinyl ethers, and, in minor amounts and particularly acrylic and/or methacrylic acid.

Suitable isocyanates used as curing agents in polyol-isocyanate primer compositions are in principle all species having two or more isocyanate groups, i.e. diisocyanates and polyisocyanates.

In principle it is possible to subdivide the diisocyanates into aromatic diisocyanates such as, for example, 2,4- and 2,6-tolylenediisocyanate (TDI), 1,5-naphthylenediisocyanate, 1,3- and 1,4-phenylenediisocyanate, 4,4′-diphenyldimethylmethanediisocyanate, 4,4′-diphenylethanediisocyanate, or 4,4′-diphenylmethanediisocyanate (MDI) or other di- and tetraalkyl-diphenylmethanediisocyanates; cycloaliphatic diisocyanates, more particularly cycloaliphatic diisocyanates such as, for example, 4,4′-dicyclohexyl-methanediisocyanate (H₁₂MDI), isophoronediisocyanate (IPDI), cyclohexane 1,4-diisocyanate, or 2,4- and 2,6-methylcyclohexyldiisocyanate (HTDI); araliphatic diisocyanates, more particularly araliphatic diisocyanates such as, for example, xylylenediisocyanate (XDI), bisisocyanatoethyl phthalate, or m- and p-tetramethylxylylenediisocyanate (TMXDI); and aliphatic diisocyanates, more particularly aliphatic diisocyanates such as, for example, hexamethylenediisocyanate (HDI), ethylenediisocyanate, tetramethylenediisocyanate, dodecane 1,12-diisocyanate, dimer fatty acid diisocyanate, tetramethoxybutane 1,4-diisocyanate or 2,2,4- and 2,4,4-trimethylhexamethylenediisocyanate (TMDI), particularly preferred is HDI.

All afore-mentioned kinds of diisocyanates, can be employed in principle as monomers, although the use of the monomers is frequently prohibited or restricted for reasons of occupational hygiene.

Preference is therefore given to the use of oligomers or polymers of diisocyanates. Particularly preferred is the use of uretdiones, biurets, allophanates, iminooxadiazindiones and isocyanurates of diisocyanates.

Most preferred in the present invention is the use of oligomers or polymers of aliphatic and/or cycloaliphatic diisocyanates. Particularly preferred are the oligomers or polymers of at least one diisocyanate of the group consisting of HDI, H₁₂MDI and IPDI; and amongst these the isocyanurate ring containing oligomers, with particular reference to HDI oligomers, even more preferred HDI-Trimers.

It is also possible, however, to use higher-molecular polymers of the poly- and diisocyanates, or mixtures of polyisocyanates from one or more of the abovementioned groups.

The mixing ratio depends on the hydroxyl group content of the species in the master batch and the isocyanate group content of the species in the curing agent, preferably the OH-to-NCO ratio being 1.0 or greater.

It is further preferred that the solids content of the solvent-borne, two-pack compositions used as the preferred primer compositions is from 20 to 60 wt.-%, more preferred from 30 to 50 wt.-% and most preferred from 35 to 45 wt.-% based on the total weight of the primer composition.

Preferred solvents used in the solvent-borne, two-pack compositions used as the preferred primer composition are any aprotic solvents. Most preferred aprotic solvents are hydrocarbons, which can be aliphatic or aromatic: Particularly preferred are aromatic hydrocarbons as aprotic solvents, such as xylylene and its isomeric mixtures.

Preferably, the solvent-borne, two-pack compositions used as the preferred primer composition, contain sulfur containing isocyanates such as 2-toluylenesulfonyl isocyanate.

### Matting Agents (MA) and Structuring Agents (SA) Used in the Primer Composition

The primer compositions of the present invention contain matting agents (MA) and/or structuring agents (SA).

Even though a distinction between matting agents (MA) and structuring agents (SA) is not essential in the context of the present invention, since both, matting agents (MA) and structuring agents (SA) have some common properties, namely to provide a coating material with some texture, both agents are described herein separately since some properties, particularly size related properties can differ.

When the applied coating film dries, the matting agent particles produce a micro-rough surface texture. As a result, the incident light is reflected in a diffuse manner and gives the observer the impression of a matt surface. The volume median particle size (D 50) of the matting agent particles is usually smaller than the volume median particle size of the structuring agents, however both should be distributed homogeneously in the dry and/or cured coating film, if present. The volume median particle size distribution of the particles of the powder can be determined by means of laser diffraction (ISO 13320:2009). Particularly suitable for this purpose is, for example, the Mastersizer 3000 from Malvern.

The matting agents may be of an inorganic or organic nature.

Examples of inorganic matting agents are amorphous, precipitated or pyrogenic silica, silica gels and layered silicates, e.g., hydrated magnesium silicate (talc); and diatomaceous earth. The inorganic matting agents may be untreated, or surface-treated with organic compounds, e.g., with suitable wax types or with inorganic compounds. Preferred matting agents are inorganic matting agents and most preferred matting agents are silicas such as precipitated and/or pyrogenic silicas.

Examples of organic matting agents are the stearates of Al, Zn, Ca or Mg; waxy compounds such as hydrocarbon waxes, as e.g., polypropylene waxes, polyethylene waxes, paraffines, polyfluoroethylene waxes; carboxylic acid-based waxes, such as e.g. ester waxes, Montan waxes and amid waxes; and urea-formaldehyde condensates.

Matting agents are available as commercial products and are known to the skilled person. They are supplied in various particle sizes. The chosen particle size of the matting agents may be adjusted closely to the dry film thickness of the primer coat layer (P) in the usual manner. Coarse matting agents exhibit a greater matting effect for the same pore volume, but also produce a rougher film surface. The volume median particle size (D₅₀) of the matting agents is preferably in the range from 2 to less than 20 μm, more preferred 3 to 19 μm, particularly preferred from 5 to 15 μm. Such products for example on the basis of silica particles are sold under the trademark Acematt® by Evonik Industries.

Structuring agents can also be of organic or inorganic nature. They can even have the same chemical nature as the matting agents (e.g. in case of polypropylene). In such cases, it is herein distinguished between matting agents and structuring agents only by the volume median particle size (D₅₀) as determined above. If the D₅₀-value is 20 μm or larger the agent will be herein considered a structuring agent. However, again it is not necessary to exactly distinguish between both, because particles in the range of roughly about 20 μm will have structuring and matting properties. Examples of suitable structuring agents include plastic material, such as, e.g., polyamide or polyalkylenes such as polypropylene, polyethylene and polytetrafluoroethylene; or polymethyl methacrylate. Corresponding products are available, e.g., under the trade names Propyltex®, Vestosint® and Orgasol® or Shamrocks Texture® Series. Moreover, ground sand or ground glass may be used as structuring agents. The volume median particle size (D₅₀) of the structuring agents is preferably in the range from 20 to 150 μm. The particle size distribution of the particles of the powder is determined in the same way as for the matting agents. The volume median of particle size (D₅₀) is preferably from 20 to 100 μm, more preferred 30 to 90 μm, even more preferably 35 to 80 μm, and most preferably 40 to 70 μm.

While any of the above described matting agents and/or structuring agents can be used in the primer composition, it is preferred that the matting agents and structuring agents remain solid during the cure of the primer composition. This is always the case for the inorganic matting agents and inorganic structuring agents and mostly fulfilled by the high melting organic matting agents and structuring agents such as polypropylene waxes and polyamides. However, even the paraffines typically having a lower melting point in the range of 50 to 85° C. may be used in e.g. room temperature drying/curing systems.

Typically, the matting agents and/or structuring agents are employed into the primer coating compositions in form of pastes, which contain the matting agents and/or structuring agent preferably besides some binders, solvents and additives by mixing these pastes with a clearcoat composition to form the primer composition.

When using structuring agents according to the invention, it is preferred that they are used in combination with matting agents.

The combined amounts of matting agents and/or structuring agents preferably used in the primer composition preferably ranges from 0.5 to 10 wt.-%, more preferred 1 to 8 wt.-% and most preferred 1.5 to 6 wt.-%, based on total weight of the primer composition.

### Further Ingredients of the Primer Composition

Contrary to most conventional primer compositions, the primer compositions as used herein do preferably not contain further particulate components, such as pigments and/or fillers and/or metallic particles, besides the mandatory matting agents (MA) and/or structuring agents (SA). In case minor amounts of such pigments and/or fillers are contained, such amount must not conflict with the desired matting and/or structuring effect. However, one of skill in the art is able to readily reduce the amount of further pigments and/or fillers, if necessary, down to zero, if the desired matting and/or structuring effect is deteriorated by the presence of such pigments and/or fillers. Metallic particles such as zinc particles should also be avoided to prevent any reaction (local cell formation) with the subsequently applied silver metal layer (S). Preferably the primer composition is a clear coat composition.

The primer composition may also contain further binders, such as cellulose esters, particularly preferred cellulose acetobutyrate.

The primer composition may further contain typical coating additives as for examples light stabilizers, UV absorbers, thickeners, adhesion promoters, surface active agents, catalysts, flame-retardants, dyes such as colorants, wetting and dispersing agents, corrosion inhibitors such as described in WO 2017/194547 A1. Further typical additives for coatings are e.g. described in “Additives for Coatings”, J. Bieleman, Wiley-VCH, reprint 2001, pp. 248-253.

The catalysts catalyze the reaction between the binder components, particularly between the master batch and the curing agent in two-pack compositions. Suitable catalysts for epoxy/curing agent compositions as described above are e.g. those described by Johan Bieleman in the textbook “Additives for Coatings”, Wiley-VCH, reprint 2001, pp. 248-253. Suitable catalysts for epoxy/curing agent compositions as described above are e.g. those described by Johan Bieleman in the textbook “Additives for Coatings”, Wiley-VCH, reprint 2001, pp. 238-242; particularly tin or bismuth containing catalysts.

### Solvents in the Solvent-Borne Two-Pack Primer Compositions

The solvent-borne primer compositions, preferably comprise aprotic organic solvents, as already lined-out above. Typical solvents are particularly those, which are chemically inert towards the ingredients of the primer composition and particularly do not react with the other ingredients when the primer composition is being cured. Examples of such solvents are aliphatic and/or aromatic hydrocarbons such as toluene, xylene, solvent naphtha, Solvesso 100 or Hydrosol® (obtainable from ARAL), para-chlorobenzotrifluoride, ketones, such as acetone, methyl ethyl ketone, methyl propyl ketone, methyl isobutyl ketone or methyl amyl ketone, esters, such as ethyl acetate, butyl acetate, pentyl acetate or ethyl 3-ethoxypropionate, ethers, or mixtures of the afore-mentioned solvents. The aprotic solvents or solvent mixtures preferably have a water content of not more than 1%, more preferably not more than 0.5%, by weight, based on the solvent weight.

### Application of the Primer Composition to Form the Primer Coat Layer (P)

The primer compositions as used in the formation of the primer coat layer (P) in the method according to the invention can be applied by any of the typical application methods, such as spraying, knife coating, spreading, pouring, dipping, impregnating, trickling or rolling, for example. During such application, the substrate to be coated may itself be at rest, with the application equipment or unit being moved. Alternatively, the substrate to be coated, in particular a coil, may be moved, with the application unit at rest relative to the substrate or being moved appropriately.

Preference is given to employing spray application methods, such as conventional air-gun spraying, compressed-air spraying such as high-volume low pressure or low-volume low pressure spraying, airless spraying and electrostatic spray application (ESTA), for example. For each layer the coating composition can be sprayed in a single spray pass or multiple spray passes. Thus, a single primer layer is formed by one or more spray passes, preferably by up to two spray passes.

Between the spray passes the applied coating composition is allowed to flash-off at about 15 to 25° C., meaning that at least some of the solvents are allowed to evaporate. Preferred flash-off times range from 5 to 30 min, more preferred 10 to 25 min such as 15 min±5 min.

After the application of the primer composition and preferably immediately before the formation of the silver metal layer (S), the wet primer coat layer film is dried and/or at least partially cured to form the primer coat layer (P).

The layer thickness of the dried and/or at least partially cured primer coat layer is preferably in the range from 10 to 150 μm, more preferred in the rage from 30 to 80 μm and most preferred in the range from 40 to 70 μm. The layer thickness can be determined according to DIN EN ISO 2178.

The layer thickness can be adjusted by solids content of the primer composition and/or the number of spray passes.

Drying and/or at least partially curing is preferably accomplished at a temperature from about 15 to 80° C. and more preferred 20 to 60° C.; preferably for a time span ranging from about 5 min to 12 hours, more preferred 10 min to 5 hours or 15 min to 1 hour. Short-wave or medium-wave infrared drying is also possible.

The primer coat layer (P) is subsequently rinsed, preferably with distilled water.

### Activating Agents (AA)

Typically, the primer coat layer (P) is further activated to facilitate the deposition of silver layer (S) in step (ii). Activation is preferably carried out with an acid stabilized, preferably a hydrochloric acid stabilized activating agent like tin-II-salts such as tin-II-chloride, preferably by spray application. The thus activated primer coat layer (P) is subsequently rinsed, preferably with distilled water.

Preferably, the activating agent is used in form of an aqueous solution, wherein the activating agent is present in an amount of 0.5 to 10 g/L, more preferred 1 to 8 g/L and most preferred 2 to 6 g/L such as 5 g/L of the aqueous solution of the activating agent. Preferably, the activating agent employed in such aqueous solution is tin-II-chloride dihydrate.

Preferably, the stabilizing agent in the aqueous solution of the activating agents is an acid. If hydrochloric acid is used as stabilizing agent, the amount of a 37 wt.-% HCl solution employed in the aqueous solution of the activating agents preferably ranges from 100 to 300 ml/L of the aqueous solution of the activating agent.

After the activation the surface is preferably rinsed off generously with demineralized water, but not wiped with cloth or the like, until the conductivity of the rinsing water is below 30 μS.

### Step (ii)

### Silver Metal Layer (S)

The silver metal layer (S) is formed by reductive deposition from an aqueous alkaline ammoniac solution containing a soluble silver salt, the silver salt most preferably being selected from the group consisting of silver nitrate, silver acetate, silver lactate, silver sulfate and silver chloride, by use of a reducing agent. In such alkaline ammoniac solution monovalent silver is complexed as [Ag(NH₃)₂]⁺ cation. A typical concentration of the silver salt in terms of silver (Ag⁰) in such aqueous solution is from about 0.05 to 0.15 mol Ag/Liter.

The reducing agent is preferably an aldehyde containing 1 to 10 carbon atoms, such as formaldehyde or ethanol or a reducing sugar such as an aldose like glucose, fructose or galactose, preferably glucose. The reducing agent is also preferably provided as an aqueous solution.

Another preferred reducing agent is formaldehyde in form of an aqueous solution. In such aqueous solution the formaldehyde is preferably present in an amount of 0.1 to 5 wt.-%, more preferred from 0.2 to 2.0 wt.-%, such as 0.3 to 1.5 wt.-%, based on the total weight of the aqueous formaldehyde solution. If other reducing agents are used, such as the aforementioned higher aldehydes such as acetaldehyde or solutions of reducing sugars, the concentration of such reducing agents in the aqueous solutions is adapted to have approximately the same reducing potential as the comparable formaldehyde solution.

The preferred method for producing the silver metal layer (S) onto the primer coat layer (P) is so-called spray metallization. In this method, a silver metal layer is deposited by spraying on a substrate, wherein usually a two-component spray gun is used, in which emerge from two separate nozzles, the above described aqueous alkaline ammoniac silver salt solution and the aqueous solution of the reducing agent. As the solutions mix, the reducing agent reduces the silver salt contained in the aqueous alkaline ammoniac silver salt solution and metallic silver particles precipitate. The precipitated silver attaches to the substrate and forms the silver metal layer (S) presenting a similar topography as the preceding primer coat layer (P).

The layer thickness of the silver metal layer is preferably in the range from 0.5 to 2.5 μm, more preferred from 0.7 to 2.0 μm, and most preferred from 0.8 to 1.5 μm. The layer thickness can be determined according to DIN 509 55 and ISO 2177 (coulometric procedure).

The layer thickness can be adjusted by duration of contact of the mixture formed from aqueous alkaline ammoniac silver salt solution and the aqueous solution of the reducing agent with the surface of the primer coat layer (P). The longer the contact, the thicker the silver metal layer (S).

In case the layer thickness is too low, the multi-layer coating obtained in the method according to the present invention appears greyish to black and lacks sufficient metallic effect and coverage. In case the layer thickness is too high, there is a risk that the matting effect or structure/texture of the multi-layer coating obtained in the method according to the present invention is diminished.

After formation of the silver metal layer (S), the silver metal layer (S) is rinsed, preferably with deionized water, preferably until the conductivity of the rinsing water is below 30 μS and dried with circulating, dust-free, preferably filtered and preferably pre-warmed air, the air temperature preferably being from 30 to 50° C. before carrying out step (iii). Drying times are preferably from 30 min to 8 h, more preferred 1 h to 5 h.

Step (iii)

### Top Coat Layer (T)

As described above, in the method of the present invention the silver metal layer (S) is covered with at least one clear top coat layer (T), more preferably with one clear top coat layer. Such clear top coat layers usually do not contain any fillers and covering amounts of pigments. However, small amounts of transparent pigments may be acceptable, as long as the clear coat characteristics are not diminished.

### Clear Top Coat Composition

Since top coats—at least those used outdoors—are often exposed to extreme weathering conditions including temperatures as low as −40° C. or up to 60° C., extreme sunlight exposure, acidic rain, sand and gravel, the first choice is most often to use two-pack coating compositions or one-pack baking varnishes, which resist such conditions.

Preferably solvent-borne clear coat compositions are used to prepare the clear top coat layer(s).

Amongst the solvent-borne clear coat compositions it is further preferred to use two-pack coating compositions.

Further, amongst the solvent-borne, two-pack clear coating compositions those based on polyol-isocyanate chemistry are preferred.

The preferred solvent-borne, two-pack, polyol-isocyanate clear coating compositions are preferably composed of the polyols and isocyanates which are described for the polyol-isocyanate primer compositions. Therefore, the polyols and isocyanates described for the primer composition are also suitable for the clear coat composition. Preferences given to certain types of polyols and certain types of isocyanates with respect to the primer compositions also apply to the clear coat composition.

Therefore, e.g. as polyols most preferably the above described poly(meth)acrylate polyols and/or polyester polyols are used. As to the isocyanates, preference is given to the use of oligomers or polymers of diisocyanates. Particularly preferred is the use of uretdiones, biurets, allophanates, iminooxadiazindiones and isocyanurates of diisocyanates. Most preferred is the use of oligomers or polymers of aliphatic and/or cycloaliphatic diisocyanates. Particularly preferred are the oligomers or polymers of at least one diisocyanate of the group consisting of HDI, H₁₂MDI and IPDI; and amongst these the isocyanurate ring containing oligomers.

While the polyols and isocyanates used in polyol-isocyanate clear coat composition are not mandatorily the same as used in the primer composition, it is however possible that the same polyols and isocyanates are used in the primer composition and the clear coat composition, respectively.

Therefore, in a preferred embodiment, the primer composition and the clear coat composition differ essentially in that the primer composition further comprises at least one matting agent and/or structuring agent, while the clear coat composition does not. However, it is preferred that the clear coat layer further comprises typical top coat additives such as UV-absorbers and the like.

Solvents as used in the solvent-borne two-pack clear coat compositions as well as further ingredients are the same as described for the primer compositions.

The clear coat composition can be slightly pigmented to achieve a color effect, if desired. However, the pigmentation is preferably at a very low concentration, depending on the pigment(s) used therein. While the lower limit of pigments is 0 wt.-% based on the total weight of the clear coat composition, the upper limit is pigment-depending and should still guarantee the desired metallic appearance, matting/structuring effect, gloss and polishability. If a color effect is desired, it is however preferred to use soluble colorants such as inks instead of or addition to pigments to thereby avoid pigments of lower their content.

The application methods for the clear coat compositions to form the cleat top coat layer (T) are the same as described for the primer compositions. However, it is also preferred, that the clear coat composition contains levelling agents as additives to ensure a smooth surface, which further enhances the gloss.

Again, preference is given to employing spray application methods, such as conventional air-gun spraying, compressed-air spraying such as high-volume low-pressure or low volume low pressure spraying, airless spraying and electrostatic spray application (ESTA), for example. For each layer the coating composition can be sprayed in a single spray pass or multiple spray passes. Thus, a single primer layer is formed by one or more spray passes, preferably by 1-2 spray passes.

Between the spray passes the applied coating composition is allowed to flash-off at about 15 to 25° C., meaning that at least some of the solvents are allowed to evaporate. Preferred flash-off times range from 1 to 10 min, more preferred 2 to 5 min such as 3 min±1 min.

For the preferred solvent-borne two-pack, clear coat compositions, drying and curing is preferably accomplished at a temperature from about 15 to 80° C. and more preferred 20 to 70° C.; preferably for a time span ranging from about 5 min to 12 hours, more preferred 10 min to 5 hours or 15 min to 1 hour. Short-wave or medium-wave infrared drying is also possible.

The layer thickness of the dried and cured clear top coat layer is preferably in the range from 20 to 200 μm, more preferred in the range from 30 to 100 μm, and most preferred in the range from 40 to 60 μm. The layer thickness can be determined as lined out above. In case that more than one clear top coat layer is applied, the afore-mentioned thickness and thickness ranges, respectively, refer to the sum of the thicknesses of all clear top coat layers.

The layer thickness can be adjusted by solids content of the clear coat composition and/or the number of spray passes.

### Multi-Layer Coated Substrate According to the Present Invention

A further aim of the present invention was to provide a multi-layer coated substrate having a high-gloss, being polishable and having a matt and/or structured metallic effect. Such multi-layer coating is obtainable by the method according to the present invention.

This aim was achieved by providing a multi-layer coated substrate comprising
(a) a substrate;
(b) a primer coat layer (P) on top of the substrate, the primer coat layer containing one or more particulate components selected from the group consisting of matting agents and structuring agents;
(c) a silver metal layer (S) on top of the surface of the coating layer (P); and
(d) one or more clear top coat layers (T) on top of the surface of the silver metal layer (S).

Preferably the substrate is selected from the group consisting of metals, alloys, polymers, wood, glass, mineral-based materials and composites of any of the afore-mentioned materials. Any of the substrates can be pre-treated and/or pre-coated as describes above. Further preferred embodiments of the substrate and the methods of pre-treating and pre-coatings are already described above.

The layer thickness of the dried and/or at least partially cured primer coat layer (P) is preferably in the range from 10 to 150 μm, more preferred in the rage from 30 to 80 μm and most preferred in the range from 40 to 70 μm. The layer thickness can be determined by DIN EN ISO 2178.

The layer thickness of the silver metal layer (S) is preferably in the range from 0.5 to 2.5 μm, more preferred from 0.7 to 2.0 μm, and most preferred from 0.8 to 1.5 μm. The layer thickness can be determined according to DIN 509 55 and ISO 2177 (coulometric procedure).

The layer thickness of the dried and cured clear top coat layer (T) is preferably in the range from 20 to 200 μm, more preferred from 30 to 100 μm most preferred from 40 to 60 μm. The layer thickness can be determined as lined out above. Preferably one clear top coat layer is present. In case that more than one clear top coat layer is applied, the afore-mentioned thickness refers to the sum of the thicknesses of all clear top coat layers.

The matting agents (MA) and/or structuring agents (SA) being contained in the primer coat layer (P) are the same as already described above having the same preferred volume median particle sizes as described above.

Preferably the primer coat layer (P) is a clear coat layer.

It is further preferred that both, the primer coat layer (P) and the clear top coat layer (T), respectively, contain anti-corrosive compounds to prevent corrosion of the silver coat layer (S).

The multi-layer coated substrates according to the present invention exhibit a high gloss due to the smooth clear top coat layer(s), but also a matt and/or structured metallic appearance due to the silver coat layer (S) propagating the texture of the preceding primer coat layer (P). The multi-layer coated substrate is polishable without deteriorating the matt and/or structured metallic effect.

The multi-layered coated substrates are preferably automotive parts, appliances, household articles, electronic housings, mobile phones, music instruments, decorative articles and the like.

Further features of the invention and advantages resulting from the invention will become apparent from the following exemplary embodiment, based on which the invention will be explained.

### EXAMPLES

### Preparation of Substrates

Steel panels (30×15 cm each) coated with a cathodic electrodeposition coating and a further brown coating layer were used as substrates. For cleaning, the surface was rubbed with a cloth soaked with white spirit. After 2 minutes at ambient conditions (23° C. and approx. 50% relative humidity) the surface was roughened by hand with a fine abrasive (P600 abrasive paper) until the surface was evenly matted. The surface was then rubbed off again with a cloth soaked with white spirit until the surface was completely clean. This could be seen from the fact that the cloth no longer absorbs any colored grinding dust and further rubbing of the surface does not discolor the cloth.

### Application of the Matt/Structured Primer Layer

As a primer composition a matte solvent-borne, polyol-isocyanate two-pack composition was used. The composition was produced by using a clear coat composition which was supplemented with a matte paste and subsequently mixing the supplemented clear coat composition with a polyisocyanate containing hardener composition and a diluent.

Before adding the hardener composition and the diluent, the matte clear coat composition had about 38 wt.-% solids content.

This matte clear coat composition contained about 4.5 wt.-% matting agent (silica with an average particle size of D₅₀ 6.3 μm), about 2.6 wt.-% of a hydroxy functional polyester, about 5.2 wt.-% of cellulose acetobutyrate, about 23.2 wt.-% of a hydroxyfunctional polyacrylate resin, about 2.5 wt.-% of an additive package (containing a UV-absorber, a light stabilizer, rheology additives, benzoic acid, silicone surface additives, a catalyst and a dispersing and wetting agent) and about 62 wt.-% of a solvent mix (containing butyl acetate, methyl isobutyl ketone, Solvent Naphtha, ethyl-3-ethoxypriopionate and xylene), all based on the total weight of the matte clear coat composition before mixing with the hardener composition and the diluent mixture.

To 100 volume parts of this matte clear coat composition 50 volume parts of a hardener composition containing about 56 wt.-% of a hexamethylene diisocyanate trimer, about 0.4 wt.-% of a water scavenger and about 43.6 wt.-% of a solvent mix (containing Solvent Naphtha, methoxypropyl acetate, butyl glycol acetate and methyl isoamyl ketone), all based on the total weight of the hardener composition, were added. Finally, 10 volume parts of a diluent mixture (containing butyl acetate, Solvent Naphtha, xylene, methoxypropyl acetate, butyl glycol acetate and Shellsol A150 ND) were added.

This ready-to-use mixture was applied by means of an air atomizing spray gun. A Compliant flow cup gun with 1.3 mm nozzle needle and 2 bar spray pressure was used. The application of the mixture was done by hand. Approx. 100 μm (wet film thickness) of these mixtures were applied with 2 spray passes on each panel.

The coated steel panels were stored for 20 min at ambient conditions (23° C. and 50% relative humidity). These pre-dried panels were then dried at 60° C. for at least 20 minutes. The resulting dry film thickness was approximately 60±10 μm. After the panels have cooled down, the silver plating was carried out as follows.

### Application of the Reflective Silver Metal Layer

The surface was rinsed off generously with demineralized water, but not wiped with cloth or the like, until the conductivity of the rinsing water was below 30 μS.

For activation a tin dichloride dihydrate solution (5 g/L SnCl₂*2 H₂O) was sprayed evenly onto the entire surface with a flow cup gun (nozzle needle 1.1 mm spray pressure 2 bar). Hydrochloric acid (37 wt.-% HCL) was contained in an amount of 200 mL in 1 L of the activation solution as a stabilizing agent.

The surface was again rinsed off generously with demineralized water, but not wiped with cloth or the like, until the conductivity of the rinsing water was below 30 μS.

The mirror effect was obtained by employing of the Tollens reaction. The ammoniacal silver nitrate solution was freshly prepared for this purpose. Otherwise the highly explosive silver nitride Ag₃N would precipitate.

The ammoniacal silver nitrate solution was prepared by dissolving 17 g silver nitrate in 1 L of water and subsequently ammonia solution was added until a white precipitate forms up to the point at which it again dissolves. After that a sodium hydroxide pellet were added and dissolved and about 60 mL of a saturated glucose solution in water was added.

The mixture was prepared and sprayed evenly onto the entire surface using a flow cup gun (nozzle needle 1.1 mm spray pressure 2 bar).

The silver layer applied in this way had a layer thickness of approx. 1 μm. This thickness was reached as soon as the surface had the desired mirror effect. If the layer is too small, the surface looks black to greyish.

The waste water was neutralized with weak acids for safety reasons.

The entire surface was generously rinsed off again with demineralized water, without wiping, until the conductivity of the rinsing water was below 30 μS.

The resulting silver layer coated panels were dried for 3 hours in the painting cabin using slightly heated (approx. 40° C.) circulating clean air may.

### Application of the Clear Top Coat Layer

The clear coat composition before mixing with the hardener composition and the diluent had a solids content of about 58 wt.-% and contained about 54 wt.-% of a hydroxyfunctional polyacrylate, about 4 wt.-% of an additive mix (containing a silicone-based levelling agent, an adhesion promoter, a UV absorber, a light stabilizer, a catalyst and benzoic acid) and about 42 wt.-% of a solvents mix (containing butyl acetate, methylisobutyl ketone, Solvent Naphtha and ethyl-3-ethoxypriopionate), all based on the total weight of the clear coat composition before mixing with the hardener composition and the diluent mixture.

The ready-to-use clear coat composition was made from 100 volume parts of the above clear coat composition and 50 volume parts of hardener composition (the same as used for the primer composition) and 10 volume parts of the diluent (the same as used in the primer composition) and thus had a DIN 4 cup run-out time of 16 seconds. This mixture was processed using a flow cup spray gun, particularly a HVLP pistol (High Volume-Low Pressure) with 1.3 mm nozzle 2.5 bar air pressure and 0.7 bar internal nozzle pressure. The application was done by hand. After the first even thin coat, the surface was flashed off at room temperature for about 3 minutes. This was followed by another closed spraying pass. A wet film thickness of about 110±10 μm was applied.

The thus coated panels were stored for 20 minutes at ambient conditions (23° C. and 50% relative humidity) before being dried at 60° C. in the oven (dry film thickness 50±10 μm).

After cooling, the metallic surface appearance was optically matt, and polishable without losing the matt effect and gloss.

The same procedure was carried out using a structuring paste (containing silica with an average particle size of D₅₀=65 μm determined by laser diffraction) instead of the matting paste, the structuring paste also containing a matting agent (silica with an average particle size of D₅₀=6.3 μm determined by laser diffraction). The structuring agent was used in about half the amount of the matting agent. Again, the metallic surface appearance was optically matt but also structured, and polishable without losing the effects.

1. A method for producing a multi-layer coating on a substrate comprising the steps of
(i) forming a primer coat layer (P) on a substrate,
(ii) forming a silver metal layer (S) onto the surface of the coating layer (P); and
(iii) forming one or more clear top coat layers (T) onto the surface of the silver metal layer (S), characterized in that
the primer coat layer contains one or more particulate components selected from the group consisting of matting agents and structuring agents and
wherein the silver metal layer (S) is formed by reductive deposition from an aqueous alkaline ammoniac solution containing a soluble silver salt, by use of a reducing agent.

2. The method according to claim 1, wherein the substrate is a pre-treated or non-treated, pre-coated or non-precoated substrate selected from the group consisting of metals, polymers, wood, glass, mineral-based materials and composites of any of the afore-mentioned materials.

3. The method according to claim 1, wherein the primer coat layer (P) is formed from a primer composition, the primer composition being selected from the group consisting of solvent-borne coating compositions and water-borne coating compositions; and being a one-pack compositions or a two-pack composition.

4. The method according to claim 3, wherein the primer coat composition is a solvent-borne, two-pack coating composition.

5. The method according to claim 4, wherein the solvent-borne, two-pack coating composition is an epoxy composition or a polyol-isocyanate composition.

6. The method according to claim 1, wherein the primer coat layer (P) is a clear coat layer.

7. The method according to claim 1, wherein the matting agent is selected from the group consisting of amorphous silica, precipitated silica, pyrogenic silica, silica gels, layered silicates, diatomaceous earth, the stearates of Al, Zn, Ca or Mg, waxy compounds, carboxylic acid-based waxes and urea-formaldehyde condensates.

8. The method according to claim 1, wherein the matting agents have a volume median particle size (D₅₀) determined by laser diffraction from 2 to less than 20 μm.

9. The method according claim 1, wherein the structuring agents are selected from the group consisting of inorganic materials, polyalkylenes and polyamides.

10. The method according to claim 1, wherein the structuring agents have a volume median particle size (D₅₀) determined by laser diffraction from 20 to 150 μm.

11. The method according to claim 1, wherein the layer thickness of the silver layer is in the range from 0.5 to 2.5 μm determined coluometrical.

12. The method according to claim 1, wherein the clear top coat layer (P) is formed from a clear coat composition, the clear coat composition being selected from the group consisting of solvent-borne coating compositions and/or being a polyol-isocyanate two-pack composition.

13. A multi-layer coated substrate, obtainable according to the method of claim 1, comprising:
(a) a substrate;
(b) a primer coat layer (P) on top of the substrate,
(c) a silver metal layer (S) on top of the surface of the coating layer (P); and
(d) one or more clear top coat layers (T) on top of the surface of the silver metal layer (S); characterized in that the primer coat layer (P) contains one or more particulate components selected from the group consisting of matting agents and structuring agents.

14. The multi-layer coated substrate according to claim 13, wherein the layer thickness of the dried and/or at least partially cured primer coat layer is in the range from 10 to 150 μm determined according to DIN EN ISO 2178; the layer thickness of the silver metal layer (S) is in the range from 0.5 to 2.5 μm determined coluometrical; and the layer thickness of the cured clear top coat layer is in the range from 20 to 200 μm determined according to DIN EN ISO 2178.

15. The multi-layer coated substrate according to claim 13, wherein the volume median particle size (D₅₀) determined by laser diffraction for the matting agent is from 2 to less than 20 μm and for the structuring agent is 30 to 200 μm.

16. The multi-layer coated substrate according to claim 13, wherein the primer coat layer (P) is a clear coat layer.
